(19) United States
(12) Patent Application Publication
(10) Pub. No.: US 2006/0028704 A1
(43) Pub. Date: Feb. 9, 2006

(54) Electronic module

(75) Inventors: Shingo Inoue, Yamanashi (JP); Ken Ashizawa, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EUDYNA DEVICES INC., Yamanashi (JP)

(21) Appl. No.: 11/159,122

(22) Filed: Jun. 23, 2005

(30) Foreign Application Priority Data
Jun. 24, 2004 (JP) 2004-187112

(51) Int. Cl. G02B 26/00

(52) U.S. Cl. 359/237; 333/33

(57) ABSTRACT

An electronic module includes: a first-stage circuit producing a drive signal based on a first potential that is either a positive or negative potential; a second-stage circuit including a first element reversely driven between a second potential equal to the first potential and the drive signal, and a second element connected in a forward biasing direction toward the second potential; and a transmission line having a signal conductor over which the drive signal is transmitted to the first element, and a reference conductor maintained at a reference potential. A connection between the first potential of the first-stage circuit and the reference conductor of the transmission line and a connection between the second potential of the second-stage circuit and the reference conductor are at an equal potential.

### BACKGROUND OF THE INVENTION

1. Field of the Invention

The present invention generally relates to electronic modules having a structure in which circuits are electrically connected through a high-frequency transmission line, and more particularly, to an electronic module that includes a semiconductor laser diode and a control system therefore.

2. Description of the Related Art

Recently, the optical communications have widely been in practical use. A semiconductor laser diode (LD) is used as a light source of the optical communications. Generally, a modulator is used to module the LD. There is a type of laser diode that is directly modulated without the modulator. There is another type of laser diode that has a built-in modulator. A modulator driver is used to drive the modulator. The modulator and the modulator driver are electrically connected together through a transmission line capable of transmitting high-frequency signals. The output signal of the modulator is a high-frequency signal of a few GHz, which requires considering the impedance of the transmission line. The direct modulation has an arrangement in which the driver and the LD are connected through the transmission line. There are several types of modulators, and many modulators have a pn junction reversely biased. The LD has a pn junction that is forwardly biased. Japanese Patent Application Publication No. 2003-298175 discloses the use of a single power supply with which the forward biasing of the LD and the reverse biasing of the modulator are simultaneously realized.

FIG. 1 is a circuit diagram of the structure of an electronic module with a positive power supply. The electronic module includes a laser diode (LD) 22a and an EAM (Electro-Absorption Modulator) 22b. An EAM driver 12 is driven with a direct power supply (VCC) of +5 V, and the output thereof is connected to an anode of the EAM 22b via a transmission line 30. The cathode of the EAM 22b is connected to the power supply voltage of +5 V. The cathode and anode of the EAM 22b are coupled to each other through a termination resistor of 50 Ω. A booster circuit 40 converts the direct current voltage of +5 V into a voltage of +7 V. A constant-current circuit 42 uses the boosted voltage of +7 V, and derives therefrom a current necessary to drive the OD 22a. As described above, the structure shown in FIG. 1 uses the power supply voltages of +5 V and +7 V to bias the LD 22a and the EAM 22b.

The EAM driver 12 and the EAM 22b send and receive high-frequency signals with the +5V power supply voltage being as a reference potential. More particularly, the EAM driver 12 and the EAM 22b use the potential of +5 V with respect to the ground as a signal reference potential. In contrast, the transmission line 30 uses the ground potential as a reference.

FIGS. 2A and 2B are diagrams that explain the reference potential. More particularly, FIG. 2A is a circuit diagram of a part of the circuit configuration shown in FIG. 1, and FIG. 2B is an equivalent circuit of FIG. 2A. A direct current power supply 44 that generates the +5V power supply voltage has a high impedance, which result in inductance components L1 and L2, as shown in FIG. 2A, wherein L1 denotes the inductance component connecting the direct current power supply 44 and the EAM driver 12, and L2 denotes the inductance component connecting the direct current power supply 44 and the cathode of the EAM 22b. The lines including the inductance components L1 and L2 may be wiring lines from an external power supply connected to the EAM driver 12 and the EAM 22b, or may be power supply lines that are provided in the electronic module and are used to supply the power supply voltage to the EAM driver 12 and EAM 22b.

FIG. 3 shows a flow of a signal current on the equivalent circuit shown in FIG. 2B. A signal current output by the EAM driver 12 that is a signal source returns to the EAM driver 12 through the transmission line 30, the load (EAM) 22b, and the inductance components L2 and L1 in that order. A return path that returns the EAM driver 12 from the EAM 22b includes the inductance components L1 and L2, which are connected in series in the flow of the signal current and may cause an impedance mismatch with the transmission line 30. The impedance mismatch causes reflection and loss of signal. As the frequency of the signal current that is the high-frequency signal becomes higher, the inductance components L1 and L2 become greater, and the problem about the impedance mismatch becomes more conspicuous.

In order to solve the above problem, it is conceivable to use bypass capacitors C1 and C2 as shown in FIG. 4. The positive terminal of the direct current power supply 44 (FIG. 2B) is grounded via the bypass capacitors C1 and C2 in high-frequency operation, so that the influence of the inductance components L1 and L2 can be reduced. However, the interconnection lines of the bypass capacitors C1 and C2 include inductance components, and the problem about the impedance mismatch still remains. This means that the problems of the reflection and loss of high-frequency signal still remain.

### SUMMARY OF THE INVENTION

It is an object of the present invention to reduce the reflection and loss of high-frequency signals.

This object of the present invention is achieved by an electronic module comprising: a first-stage circuit producing a drive signal based on a first potential that is either a positive or negative potential; a second-stage circuit including a first element reversely driven between a second potential equal to the first potential and the drive signal, and a second element connected in a forward biasing direction toward the second potential; and a transmission line having a signal conductor over which the drive signal is transmitted to the first element, and a reference conductor maintained at a reference potential, a connection between the first potential of the first-stage circuit and the reference conductor of the transmission line and a connection between the second potential of the second-stage circuit and the reference conductor being at an equal potential.

The above object of the present invention is also achieved by an electronic module comprising: a first-stage circuit producing a drive signal based on a first potential that is either a positive or negative potential; a second-stage circuit including a first element forwardly driven between a second potential equal to the first potential and the drive signal; and a transmission line having a signal conductor over which the drive signal of the first-stage circuit is transmitted to the first element, and a reference conductor maintained at a reference potential, a connection between the first potential of the first-stage circuit and the reference conductor of the transmission line and a connection between the second potential of the second-stage circuit and the reference conductor being at an equal potential.

The above object of the present invention is also achieved by a transmission line comprising: a signal conductor; and a reference conductor maintained at a reference potential that is either a positive or negative potential.

The above object of the present invention is also achieved by a semiconductor device comprising: a signal terminal connected to a signal conductor of a transmission line; and a reference potential terminal that is connected to a reference conductor of the transmission line and has a positive or negative potential.

The above object of the present invention is also achieved by a transmission method comprising: transmitting a signal from a first-stage circuit over a signal conductor of a transmission line; and returning, to the first-stage circuit, the signal through a return path that includes a reference conductor of the transmission line maintained at a positive or negative potential.

### BRIEF DESCRIPTION OF THE DRAWINGS

Other objects, features and advantages of the present invention will become more apparent from the following detailed description when read in conjunction with the accompanying drawings, in which:

FIG. 1 is a circuit diagram of the structure of a conventional electronic module;

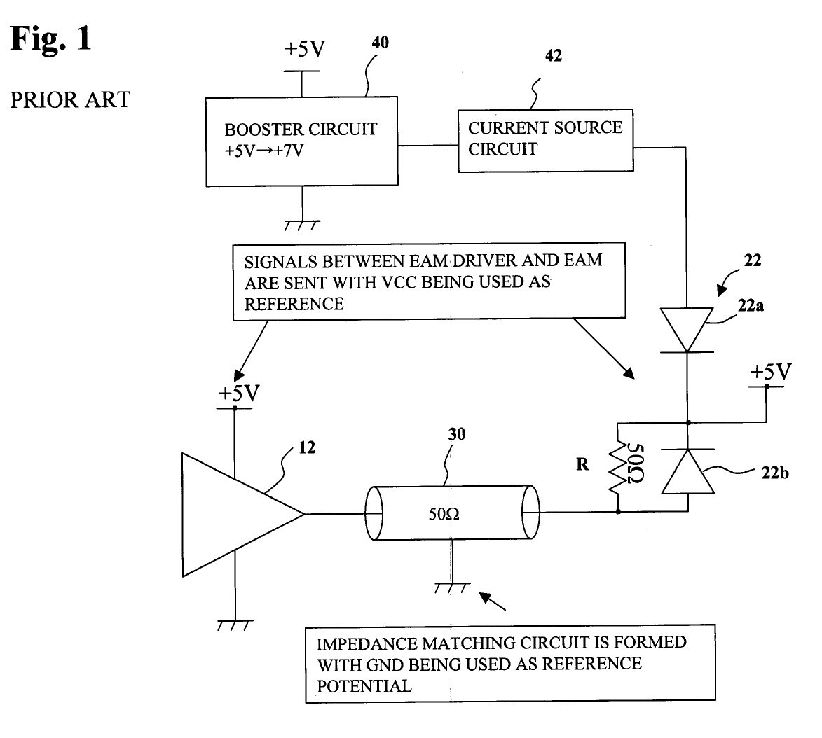

FIGS. 2A and 2B are diagrams that explains a reference potential used in the structure shown in FIG. 1;

FIG. 3 shows a flow of a signal current on an equivalent circuit shown in FIG. 2B;

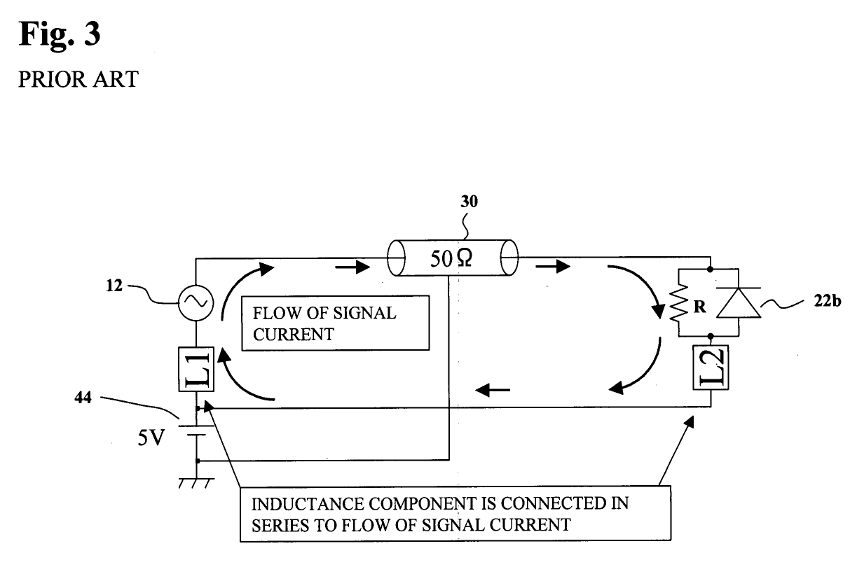

FIG. 4 is a circuit diagram of a circuit that employs bypass capacitors;

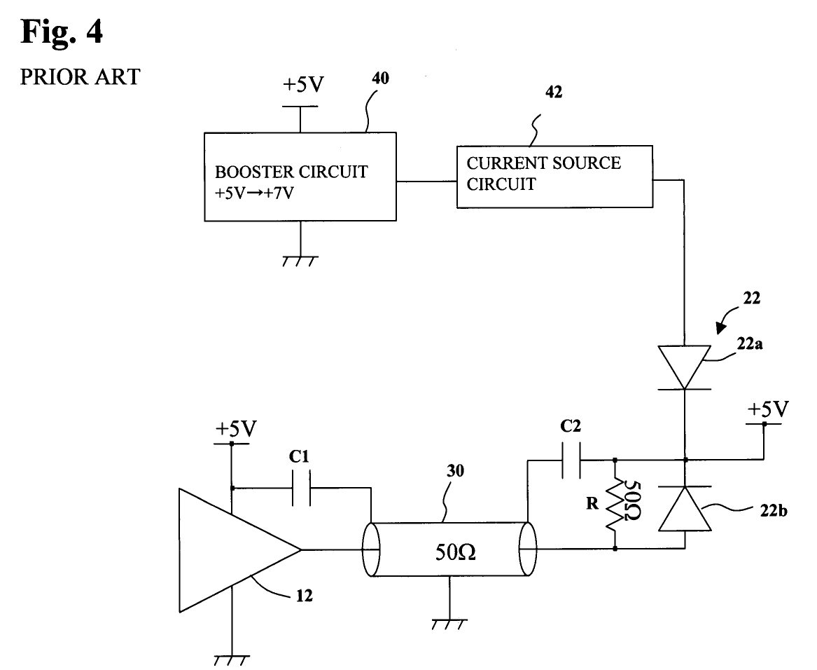

FIG. 5 is a circuit diagram of the circuit configuration of an electronic module according to an embodiment of the present invention;

FIG. 6 shows a flow of a high-frequency signal current on the circuit configuration shown in FIG. 5;

FIGS. 7A and 7B schematically show cross sections of a printed-circuit board employed in the electronic module shown in FIG. 5;

FIG. 8 is a plan view of the printed-circuit board having via interconnections;

FIG. 9 is a perspective view of a coplanar line;

FIG. 10 is a diagram of the configuration of an electronic module equipped with a direct modulation laser diode according to another embodiment of the present invention; and

FIG. 11 is a diagram of the configuration of another electronic module equipped with an LN (lithium niobate) modulator according to yet another embodiment of the present invention.

### DESCRIPTION OF THE PREFERRED EMBODIMENTS

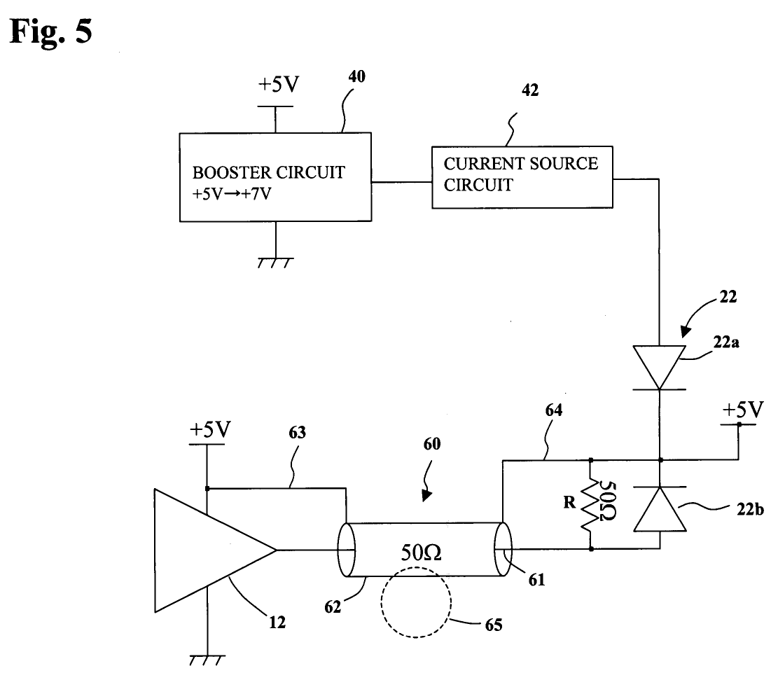

FIG. 5 shows the circuit configuration of an electronic module according to an embodiment of the present invention, in which the like reference numerals refer to like elements. A transmission line 60 is used to electrically connect the EAM driver 12 and the EAM 22b. The EAM driver 12 forms a first-stage circuit, and the EAM 22b forms a second-stage circuit together with the LD 22a. The LD 22a is forwardly biased, and the EAM 22b that is an optical modulator is reversely biased. Here, an element reversely biased like the EAM 22b is defined as a first element, and an element forwardly biased like the LD 22a is defined as a second element. The second element may be a light-emitting element (for instance, a light-emitting diode) or a light amplifier besides the LD 22a. The first and second elements may be integrated on a substrate of an identical conduction type. The EAM 22b may be a single semiconductor device. In the configuration shown in FIG. 5, the first and second elements are biased with a positive power supply. Instead of the positive power supply, a negative power supply may be used to bias the first and second elements. That is, the electronic module shown in FIG. 5 is made up of a first-stage circuit 12 that produces a drive signal based on a first potential that may be either positive or negative, the first element 22b reversely biased between a second potential equal to the first potential and the drive signal, and the second element 22a connected in the forward bias direction toward the second potential.

The transmission line 60 is composed of a conductor 61 and a reference conductor 62. In the present embodiment, the reference conductor 62 of the transmission line 60 is connected to the power supply voltage of +5 V by means of conductors 63 and 64. That is, the electronic module shown in FIG. 5 is equipped with a signal conductor over which the drive signal of the first-stage circuit 12 is transmitted to the first element 22b, and a reference conductor maintained at the reference potential. As indicated by a reference numeral 65, the reference conductor 62 of the transmission line 60 is not connected to the ground potential. The reference conductor 62 of the transmission line 60 is maintained at a positive or negative potential other than the ground potential. The characteristic impedance of the transmission line 60 is, for example, 50 Ω.

The first-stage circuit 12, and the second-stage circuit composed of the LD 22a and the EAM 22b are driven by the power supply voltage VCC that has the same polarity as the first potential. The second potential is the power supply voltage applied to the second-stage circuit, which is equipped with the booster circuit 40, which boosts the power supply voltage VCC. The second element 22a is forwardly biased between the second potential and the output of the booster circuit 40.

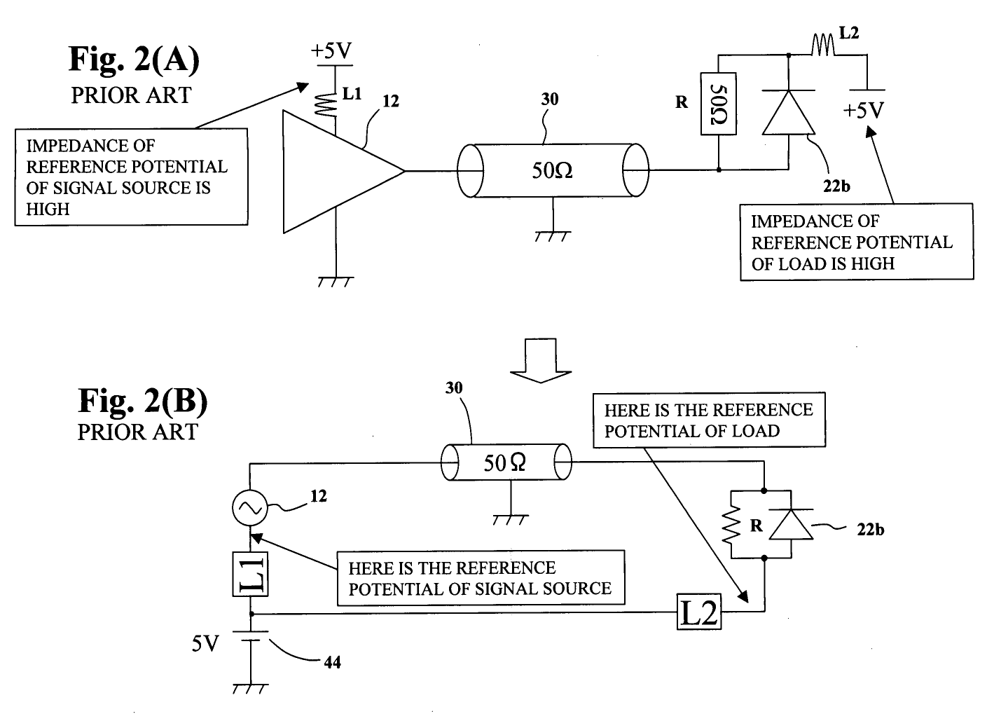

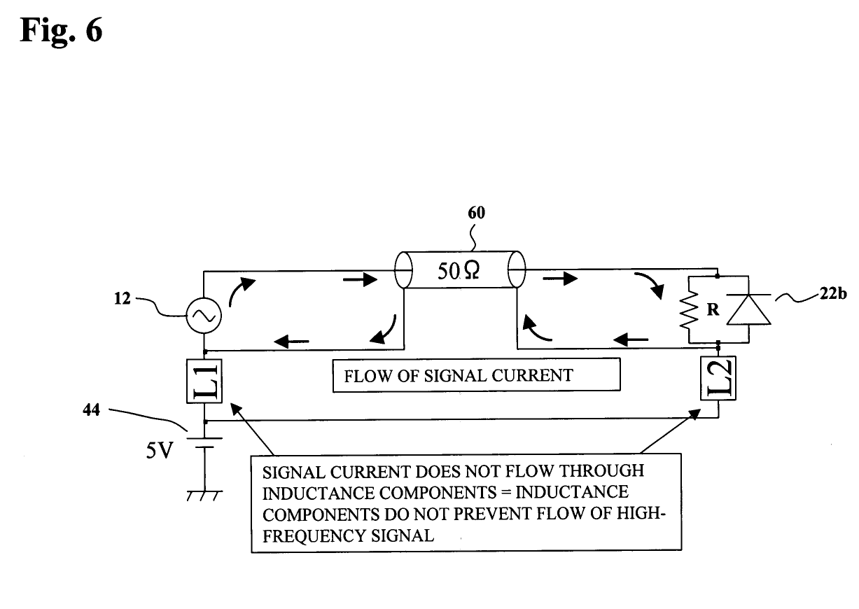

FIG. 6 shows the flow of the high-frequency signal current in the configuration shown in FIG. 5. The high-frequency signal current output by the EAM driver 12 functioning as the signal source passes through the EAM 22b of the LD 22 (load) and the transmission line 60, and returns to the EAM driver 12. The return path through which the signal current returns to the EAM driver 12 from the EAM 22b includes the transmission line 60. In the present embodiment, the positive potential of the return path is the power supply voltage of +5 V. The reference potential of the transmission line 60 coincides with the signal reference potential of the EAM driver 12 and LD 22. In contrast, in the conventional configuration, as shown in FIG. 2A, the return path of the signal current does not includes the transmission line 30, and the reference potential of the transmission line 30 is the ground potential and is different from the signal reference potential (+5 V) of the EAM driver 12 and LD 22.

The return path of the signal current formed in the configuration shown in FIG. 5 does not include the inductance components L1 and L2 of the power supply line. Since the signal current does not flow through the inductance components L1 and L2, there are not the inductance components L1 and L2 between the signal source of the EAM driver 12 and the transmission line 60 and between the transmission line 60 and the EAM 22b that is the load of the transmission line 60. Thus, in the present configuration, the reference conductor 62 of the transmission line 60 is not set at the ground potential but at the potential common to the first-stage circuit and the second-stage circuit (the first potential and the second potential; VCC in the above example). This makes it possible to form the return path that connects the first-stage circuit and the second-stage circuit via the reference conductor 62 of the transmission line 60 without separating these circuits by the bypass capacitors in DC operation and to reduce the reflection and loss of high-frequency signals.

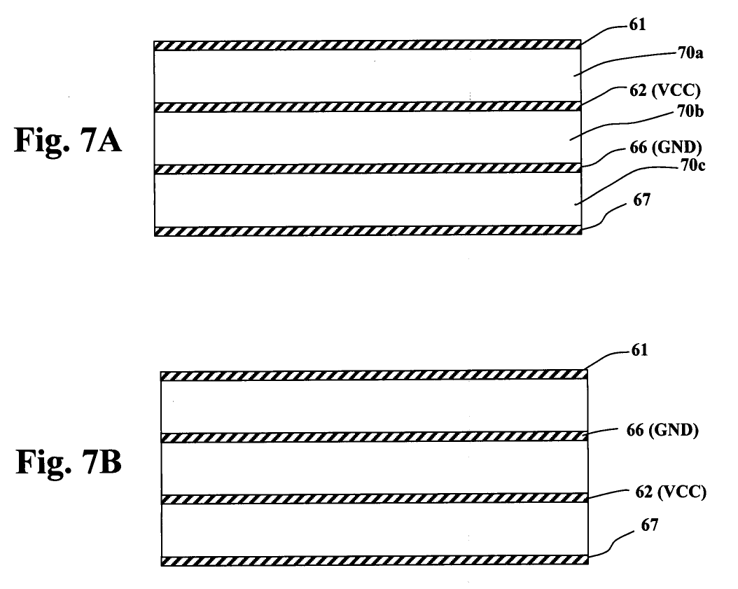

The electronic module shown in FIG. 5 may have a structure that includes a printed-circuit board 70 schematically illustrated in FIG. 7A. The printed-circuit board 70 has a multilayer structure. The printed-circuit board 70 has a plurality of dielectric layers 70a, 70b and 70c. The number of dielectric layers is not limited to three, but the printed-circuit board 70 may have an arbitrary number of dielectric layers. The EAM driver 12 and the LD 22 are mounted on a surface of the printed-circuit board 70, and the signal conductor 61 of the transmission line 60 that connects these elements is formed thereon. The signal conductor 61 connects the signal terminal of the EAM driver 12 and the signal terminal of the LD 22. The reference conductor 62 of the transmission line 60 is located below the signal conductor 61. The reference conductor 62 is at the potential common to the EAM driver 12 and the LD 22. Preferably, the reference conductor 62 is formed on the whole inner surface of the printed-circuit board 70. The reference conductor 62 is formed not only below the signal conductor 61, but also the EAM driver 12 and the LD 22. The transmission line 60 is a microstrip line formed by the signal conductor 61, the dielectric layer 70a and the reference conductor 62. The microstrip line continues from the signal terminal of the EAM driver 12 to the signal terminal of the LD 22. Thus, the transmission line 60 functions as an impedance matching line that matches the impedance with the EAM driver 12 and the LD 22. It is thus possible to greatly reduce the reflection and loss of the high-frequency signals.

A ground-potential layer 66 is formed below the reference conductor 62 of the transmission line 60 through the dielectric layer 70b. A signal conductor 67 that transmits a low-frequency signal is formed below the ground-potential layer 66 through the dielectric layer 70c. The signal conductor 67 is provided on the backside of the printed-circuit board 70.

The conventional configuration employs the reference potential of the transmission line 30 that is at the ground potential, and the structure shown in FIG. 7A cannot be applied thereto. The conventional configuration requires a structure shown in FIG. 7B in which a microstrip line is configured so that the reference conductor at the ground potential is arranged just below the signal conductor of the transmission line 30.

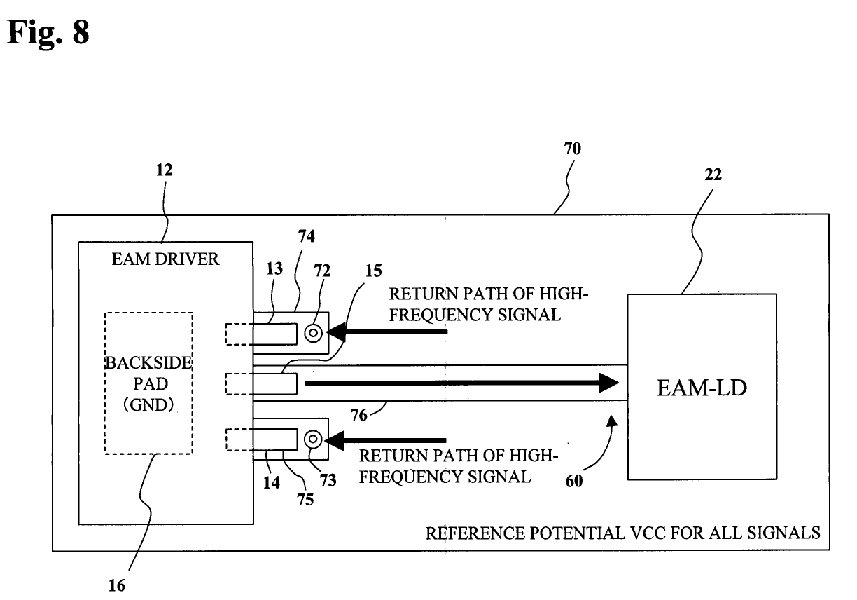

The reference conductor 62 shown in FIG. 7A are electrically connected to the EAM driver 12 and the LD 22 by means of via interconnections formed in the printed-circuit board 70. The via interconnections correspond to the conductors 63 and 64 shown in FIG. 5. An exemplary structure of the via interconnections are illustrated in FIG. 8. Power supply terminals 13 and 14 of the EAM driver 12 are connected to the reference conductor 62 by means of via interconnections 72 and 73 formed in conductive patterns 74 and 75. The power supply terminals 13 and 14, which are set at the positive reference potential (equal to +5 V in the present embodiment) are located at and adjacent to both sides of a signal terminal 15 connected to the signal conductor 61 formed by a conductive pattern 76. The EAM driver 12 is formed by a single semiconductor device, this semiconductor device has the signal terminal 15 connected to the signal conductor 61 of the transmission line 60, and the power supply (reference) terminals 13 and 14 connected to the reference conductor 62. Preferably, the power supply terminals 13 and 14 are located at and close to opposite sides of the signal terminal 15. This arrangement of the terminals 13-15 causes the high-frequency signal to return to the EAM driver 12 via the EAM driver 12, the signal conductor 67, the LD and the reference conductor 62.

The present embodiment has the turn path that has, instead of the power supply line used in the conventional configuration, the reference conductor 62 that has a large cross section and a small inductance component. It is thus possible to reduce the signal reflection and loss because of the presence of the inductance components that are disfavored in the return path. The via interconnections 72 and 73 that function as the conductors 63 and 64 have small inductance components, which do not greatly reflect and attenuate the signal current. Backside pads 16 are provided on the rear surface of the package of the EAM driver 12, and are connected to the ground-potential layer 66 shown in FIG. 7A by means of a via interconnection formed in the printed-circuit board 70. The reference conductor 62 has a hole through which the via interconnection connected to the ground-potential layer 66 passes. Similarly, Other terminals of the EAM driver 12 are connected to conductive layers provided on inner layers and/or the bottom of the printed-circuit board 70 through via interconnections. Although omitted in FIG. 8, the terminals of the LD 22 are connected to the reference conductor 62, the ground-potential conductor 66 and the signal conductor 67 through via interconnections in the same manner as mentioned above.

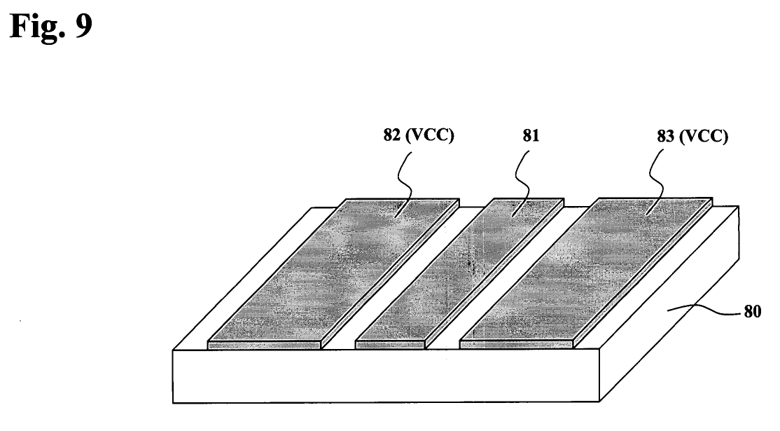

The transmission line used in the present invention is not limited to the microstrip line but may have another type of transmission line such as a coplanar line and a coaxial cable. FIG. 9 shows an example of the coplanar line. A signal line 81 and reference conductors 82 and 83 arranged at both sides of the signal line 81 are formed on a printed-circuit board 80 made of a dielectric substance. The reference conductors 82 and 83 are at a positive potential with respect to the ground potential, which may be the potential of the power supply that drives the EAM driver 21, the LD 22a and the EAM 22b. The reference conductors 82 and 83 are connected to the power supply terminals 13 and 14 of the EAM driver 12 shown in FIG. 8, and are also connected to the power supply terminals of the LD 22a and the EAM 22b. The signal conductor 81 is connected to the signal terminal 15 of the EAM driver 12 shown in FIG. 8 and the signal terminal of the EAM 22b. The printed-circuit board 80 may have a multilayer interconnection structure. As well as the microstrip line, the reference conductors 82 and 83 form the return path, which does not include the power supply line as in the case of the conventional structure.

The coaxial cable has a signal conductor surrounded by an outer conductor that corresponds to the reference conductor. The coaxial cable brings about the same advantages as described before.

The above-mentioned embodiment employs the transmission line 60 that connects the EAM driver 12 and the EAM 22b. The present invention includes another type of electronic module driven with the single power supply. The following are two examples of this type.

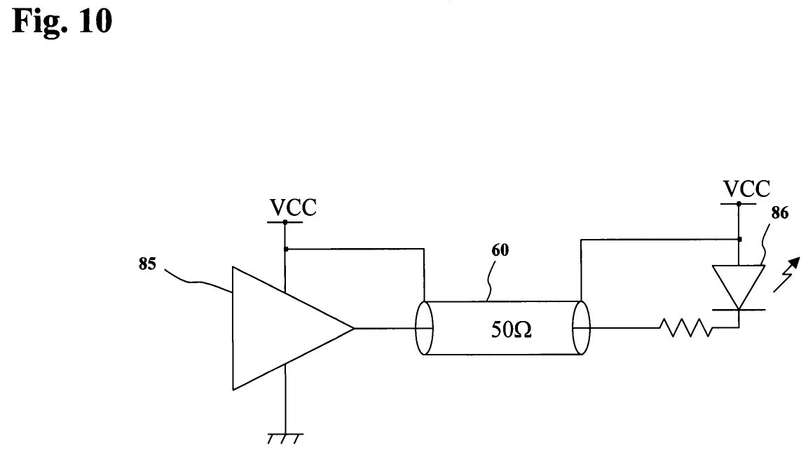

FIG. 10 shows an electronic module equipped with a direct modulation laser diode according to an aspect of the present invention. The transmission line 60 connects a direct modulation LD driver 85 and a direct modulation LD 86. The signal reference potential of the transmission line 60 is set at VCC (for example, +5 V). The configuration shown in FIG. 10 brings about the same functions and advantages as those of the aforementioned embodiments of the present invention. The structures shown in FIGS. 7A, 8 and 9 are applicable to the electronic module shown in FIG. 10.

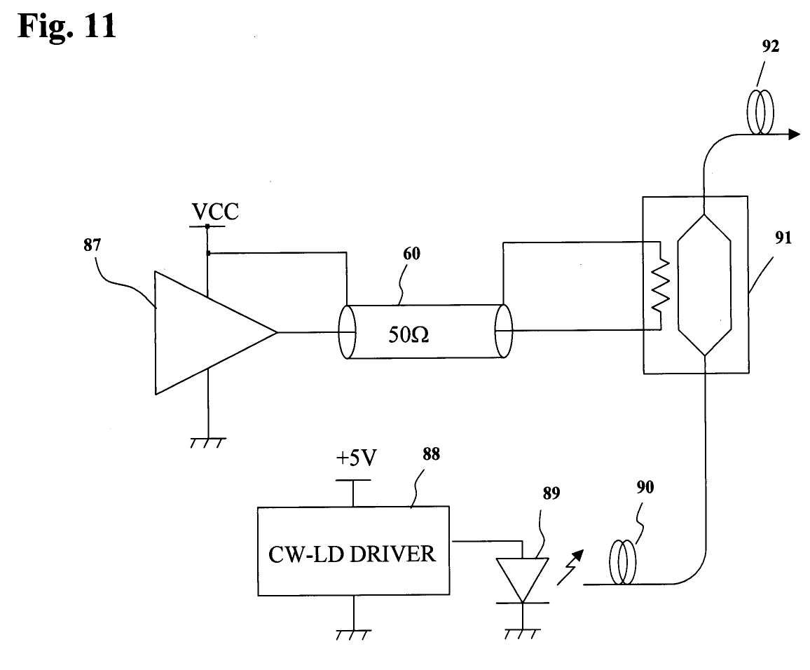

FIG. 11 shows an electronic module equipped with an LD modulator according to another aspect of the present invention. The transmission line 60 connects an LN driver 87 and an LN modulator 91. A CW (Continuous Wave) type laser diode (CW-LD) 89 is driven by a CW-LD drive circuit 88 driven by +5 V. The light output of the CW-LD 89 is applied to the LN modulator 91 via an optical fiber 90. The LN modulator 91 is modulated by the high-frequency signal transmitted over the transmission line 60. The modulated light is transmitted to the outside of the electronic module through an optical fiber 92. The structures shown in FIGS. 7A, 8 and 9 are applicable to the electronic module shown in FIG. 11.

The present invention is not limited to the specifically disclosed embodiments, and variations and modifications may be made without departing from the scope of the present invention.

The present application is based on Japanese Patent Application No. 2004-187112 filed on Jun. 24, 2005, the entire disclosure of which is hereby incorporated by reference.

What is claimed is:

1. An electronic module comprising:
a first-stage circuit producing a drive signal based on a first potential that is either a positive or negative potential;
a second-stage circuit including a first element reversely driven between a second potential equal to the first potential and the drive signal, and a second element connected in a forward biasing direction toward the second potential; and
a transmission line having a signal conductor over which the drive signal of the first-stage circuit is transmitted to the first element, and a reference conductor maintained at a reference potential,
a connection between the first potential of the first-stage circuit and the reference conductor of the transmission line and a connection between the second potential of the second-stage circuit and the reference conductor being at an equal potential.

2. The electronic module as claimed in claim 1, wherein the first-stage circuit and the second-stage circuit are driven by a power supply having a polarity identical to that of the first potential.

3. The electronic module as claimed in claim 1, wherein:
the second potential is equal to a power supply voltage of the second-stage circuit;
the second-stage circuit includes a boost circuit that boosts the power supply voltage; and
the second element is forwardly biased between the second potential and an output of the boost circuit.

4. The electronic module as claimed in claim 1, wherein the transmission line is one of a microstrip line, a coplanar line and a coaxial cable.

5. The electronic module as claimed in claim 4, wherein:
the transmission line is a microstrip line provided on a printed-circuit board having a ground-potential layer; and
a signal conductor of the microstrip line, a reference conductor thereof, and the ground-potential layer of the printed-circuit board are laminated in this order.

6. The electronic module as claimed in claim 4, wherein:
the transmission line is a coplanar line provided on a printed-circuit board; and
the coplanar line has a signal conductor sandwiched between reference conductors.

7. The electronic module as claimed in claim 1, wherein the first element is an optical modulator, and the second element is a light-emitting element or an optical amplifier.

8. The electronic module as claimed in claim 7, wherein the first and second elements are integrated on a semiconductor substrate of an identical conduction type.

9. The electronic module as claimed in claim 7, wherein the optical modulator is an electro-absorption modulator.

10. The electronic module as claimed in claim 7, wherein the optical modulator is an LN modulator.

11. An electronic module comprising:
a first-stage circuit producing a drive signal based on a first potential that is either a positive or negative potential;
a second-stage circuit including a first element forwardly driven between a second potential equal to the first potential and the drive signal; and
a transmission line having a signal conductor over which the drive signal is transmitted to the first element, and a reference conductor maintained at a reference potential,
a connection between the first potential of the first-stage circuit and the reference conductor of the transmission line and a connection between the second potential of the second-stage circuit and the reference conductor being at an equal potential.

12. The electronic module as claimed in claim 11, wherein the first element is a light-emitting element or a light amplifier.

13. The electronic module as claimed in claim 11, wherein the first potential is a positive potential.

14. A transmission line comprising:
a signal conductor; and
a reference conductor maintained at a reference potential that is either a positive or negative potential.

15. A semiconductor device comprising:
a signal terminal connected to a signal conductor of a transmission line; and
a reference potential terminal that is connected to a reference conductor of the transmission line and has a positive or negative potential.

16. A transmission method comprising:
transmitting a signal from a first-stage circuit over a signal conductor of a transmission line; and
returning, to the first-stage circuit, the signal through a return path that includes a reference conductor of the transmission line maintained at a positive or negative potential.
